(19) United States
(12) Patent Application Publication
(10) Pub. No.: US 2022/0118647 A1
(43) Pub. Date: Apr. 21, 2022

(54) METHOD AND KIT FOR TREATING WOOD WITH RED UNDERTONES

(71) Applicant: DEBAL COATINGS, Roeselare (BE)

(72) Inventors: Pascal DELBAERE, Roeselare (BE); Wouter DEVAERE, Roeselare (BE)

(21) Appl. No.: 17/422,420

(22) PCT Filed: Jan. 10, 2020
(86) PCT No.: PCT/IB2020/050167

§ 371 Date: Jul. 12, 2021

(30) Foreign Application Priority Data
Jan. 11, 2019 (BE) BE2019/5018

(51) Int. Cl. B27K 5/02; C09D 15/00

(52) U.S. Cl. CPC B27K 5/02; C09D 15/00

(57) ABSTRACT

In a method for treating wood with red and/or pink undertones to bring it to the desired colour, the wood is provided with one or more finishing layers with the desired colour, and before the finishing layer is applied the wood is provided with a neutralization layer to neutralize the red and/or pink undertones of the wood to be treated. A kit of two different aqueous solutions, which are applied as a single composition for treating wood with red and/or pink undertones, is suitable for neutralizing the red and/or pink undertones of the wood to be treated. The composition is a mixture of a first and a second component, wherein the first component is a solution of a reactive dye in water and the second component is an aqueous alkaline solution, which is suitable for forming covalent bonds with the fibres of the wood to be treated.

### FIELD OF THE DISCLOSURE

The present disclosure relates on the one hand to a method for treating wood with red and/or pink undertones to bring it to the desired colour, wherein the wood is provided with a finishing layer with the desired colour. The wood to be treated is preferably: American red oak, beech, birch, maple, Tasmanian oak, white oak, etc. On the other hand, the present disclosure relates to a kit of two different aqueous solutions, which are applied as a single composition for treating wood with red and/or pink undertones, which is suitable for neutralizing the red and/or pink undertones of the wood to be treated.

### BACKGROUND

The reduced availability of preferentially used wood species (including inter alia European oak) plus the associated economic reality means that in certain segments of the wood-processing industry the use of alternative wood species is becoming more attractive. The qualitative characteristics of the finished products must of course be guaranteed; the decorative aspect is an important aspect and up to now this has been seen as a limiting factor.

Alternative species that come into consideration on the basis of availability, properties and durability have, by their nature, the disadvantage that on the basis of the classical wood-colouring techniques in general rather unattractive, unnatural-looking finishes are obtained, so that these can only be used in a limited way and not as a valid alternative for high-grade species, for example such as European oak. A recurring problem is the red hue (undertone) of the wood, which is associated with the extractive contents of the wood and is further pronounced by the classical finishing technologies.

Wood may best be defined as a cellular lignocellulosic material consisting of cellulose fibres that are embedded in a matrix of hemicellulose and lignin. The composition and structure of wood varies from species to species, mutually between cell types and within the cell wall itself. The natural light-yellow colour of wood is most probably caused by chromophores in the lignin and the characteristic colour is determined by the constituents present, typically phenolic substances (such as e.g. quinones).

To give wood long-term protection, it is known from EP 2 003 977 (WO 2007/111556) to apply a kit of two aqueous compositions successively on the wood, wherein the first solution is an alkaline solution that comprises potassium silicate, and the second solution comprises an alkoxy-silane. The use of Na₂SiO₃ or related silicate solutions provides preservation of cellulose-containing materials (including wood). By their nature, these aqueous solutions are located in the alkaline region (pH depending on concentration) and basically artificial fossilization of the wood is achieved hereby. The alkoxy-silane, which is applied in a second step, serves for hydrophobization and long-term protection of the wood. A covalent bond is obtained by a condensation reaction between cellulose and the silane polymer.

It is known to treat wood so that its appearance is altered so that it resembles another type of wood, and besides availability, creation of added value by upgrading is the most important motive. The desired effect is preferably a colour. Thus, in the American patent publication U.S. Pat. No. 4,959,076, a method is described for treating wood of the genus Juglans (walnut) to alter its colour through the whole structure so that a substitute for rosewood (palisander—genus Dalbergia) is obtained, so as to meet the demand for rosewood.

U.S. Pat. No. 7,537,619 discloses a method and a system for treating birch wood to alter its colour so as to resemble that of cherry wood or birch heartwood. This wood is far less expensive than cherry wood and is available in large amounts. By transforming the colour, this wood becomes more commercial.

The methods described in U.S. Pat. Nos. 4,959,076 and 7,537,619 have the disadvantage that it is a complicated and time-consuming process that only offers a solution for one specific problem. This approach certainly has its advantages, but is not universally applicable. Moreover, it does not offer an answer to the pink/red problem, wherein after colouring and further wood finishing, a red/pink undertone is still visible. In addition, the method described cannot be used for on-site colouring of wood, which certainly in the woodflooring industry now represents an important part of the market. Staining is currently the most used technique for colouring wood, and various possibilities exist for this depending on the intended result and the substrate used, and provided that a number of rules are respected, this technique is almost universally applicable.

Firstly a distinction should be made between dye and pigment staining. Technically, a dye stain is a solution of a dye in a solvent such as e.g. alcohol, water or in an oil-based solvent. The dissolved dye “particles” are of molecular size and can penetrate deep into the cellular structure of the wood and/or bond with the wood. A pigment stain is in essence a very thin paint that consists of a finely ground pigment, an oil- or water-based vehicle and a binder that ensures that the pigment is fixed on the wood. Pigment particles are larger than dye particles and when applied on wood, they tend to remain on the surface or to sink into the pores (grain pattern). Dye stains provide more transparency and deeper colour than pigment stains, which because of their opacity provide better covering. Commercial stains often comprise both pigments and dyes.

Currently, owing to their physical nature, being soluble in non-polar media, solvent dyes find a number of applications (oils and washes, ballpoint pens, printing inks, etc.), but solvent stains are being used to an ever decreasing extent in the wood-processing industry on account of their environmental burden. Because of this, water soluble dyes (dye staining) are a good alternative. The main application of these dye stains is the textile industry.

A first group of dye stains comprises the metal-complex and direct dyes (e.g. Basantol/CLW series) dissolved in water or in a mixture of water, glycol ether, glycol. The mechanism of direct dyeing on cellulose fibres comprises adsorption, diffusion and migration over the fibre. When the cellulose fibre is moistened, the amorphous regions of the fibre swell and the molecules of colouring matter of smaller size diffuse through these pores in the fibre structure. For application of the stain, techniques such as spraying, brushing and rolling are used, the stained layers, whether or not after forced drying, can be painted over quickly and, although there is no consensus on this, preferably be finished with coatings based on organic solvents. Because, for adhesion to the cellulose fibre, direct dyes depend on intermolecular forces of lower binding energy, such as hydrogen bridges and van der Waals forces, they are sensitive to changes in the external environment: with double staining, the dyes easily dissolve again and the intended effect is lost; for the same reason finishing with water-based products (e.g. rolling) is less recommended.

A second group of dye stains are the acid dyes (e.g. Basacid), which as a rule are used for colouring protein fibres (silk, wool, feathers, etc.) and nylon, but are also used in typical wood stains. Acid dyes comprise acidic molecular groups such as —SO₃H and work optimally in an environment with low pH and a mild acidic “fixing agent” (e.g. vinegar or citric acid). It is assumed that acid dyes bind to fibres by hydrogen bonding, van der Waals forces and ionic bonding. The same limitations apply to the acid dyes as to the metal-complex and direct dyes. At the end of the staining process, the pH value of the stain is lowered, depending on the type of wood that is used. The reason for this is that organic acids that are present in most wood species (typically oak, cedar) cause an increase in the H₃O⁺ concentration; this supports the fact that acid dyes are used in practice.

A dye that is able to react chemically with a substrate to form a covalent substrate-coupling is known as a reactive dye, forming the third group of dye stains. Here the dye contains a reactive group that enables covalent bonding (nucleophilic substitution or addition reaction) with the fibre polymer and thus becomes a component of the fibre. This covalent bond is formed between the dye molecules and the terminal hydroxyl groups, which are abundant in the cellulose fibres. These dyes form an important group in textile dyeing. They have good light-fastness and very good water resistance (in textile terms: wash-fastness). Various techniques are known and have been optimized. It is assumed that during dyeing, when the fibre is saturated with water, the dye solution diffuses in the fibre under a concentration gradient, is adsorbed and then penetrates into the fibre.

The Chinese patent publication CN 101 864 674 A describes a known technique from textile dyeing wherein a method is explained for the preparation and dosing of the components of a dyeing liquid, with the aim of minimizing hydrolysis of the reactive dye.

Owing to the affinity with cellulose, the use of reactive dyes for colouring wood could be considered, but colouring of wood with the known reactive dyes has an important disadvantage, namely the fact that besides the reaction with the wood fibres, a hydrolysis reaction will inevitably occur, and hydrolysis is in direct competition with fixation (bonding) of the dye. In addition, there is no process that is simple to implement and universally applicable.

From British patent publication GB 789 485, it is known to apply first a solution on the surface of untreated wood, such as among others poplar, walnut and mahogany, which behaves as a staining agent, and then apply a dye with basic or acidic properties, which will react with the staining agent already applied so that an insoluble dye is formed in the pores of the wood. The staining agent used, which impregnates the wood, is a substance that reacts with an acid or an oxidizing agent or a substance with basic reaction or a reducing agent, more specifically strong oxidizing or reducing chemicals such as NaHS—NaClO—SnCl₂ are mentioned. These are all substances whose bleaching action is known. Bleaching is a technique that up to now has mainly been used at the craft scale to remove the colour from wood, to reset it, as it were. The process described in GB 789 485 has the disadvantages that it is labour-intensive, is not durable and is not reproducible, a further limiting factor following from the technique described is the fact that for subsequent colouring we are limited to the basic or acid dyes.

### SUMMARY

Now, the present disclosure provides methods with which it is possible to bring wood with red undertones to the desired colour (finishing) without a red and/or pink undertone still being visible afterwards. The methods may in addition be easy to apply, and preferably applicable on site. The present disclosure also provides a kit for treating and/or colouring wood, which offers a solution for the competition between hydrolysis of the reactive dyes and fixation with the wood.

The disclosure provides a method for treating wood with red and/or pink undertones to bring it to the desired colour, wherein the wood is provided with one or more finishing layers with the desired colour, wherein before the one or more finishing layers are applied, the wood is provided with a neutralization layer in order to neutralize the red and/or pink undertones of the wood to be treated, wherein the neutralization layer is a mixture of a first and a second component, which is applied as a single composition, wherein the first component is a solution of a reactive dye in water and the second component is an aqueous alkaline solution suitable for forming covalent bonds with the fibres of the wood to be treated. Said fibres are preferably cellulose fibres. The two components will be mixed together just when the method is to be carried out and the neutralization layer is to be applied. Consequently, when carrying out the method, the mixture should be formed just before it is applied, by mixing the first and the second component together. The alkaline environment is necessary for the bonding of the dye, preferably a reactive dye that is provided in the first component. After application of the neutralization layer, a further one or more finishing layers may be applied, in some applications even up to seven. Preferably, the first finishing layer that is applied after application of the neutralization layer comprises a water-based colouring stain or an ageing stain.

The present disclosure further relates to a kit of two different aqueous solutions, which are applied as a single composition for treating wood with red and/or pink undertones, which is suitable for neutralizing the red and/or pink undertones of the wood to be treated, wherein said kit is a mixture of a first and a second component, wherein the first component is a solution of a reactive dye in water and the second component is an aqueous alkaline solution suitable for forming covalent bonds with the fibres of the wood to be treated. Preferably the first and second components are supplied in separate packs. Prior to application, the two packs are opened and mixed together into a single solution, which is then applied on the wood to be treated.

### DETAILED DESCRIPTION

For further explanation of the properties of the disclosed methods and kits and to present additional advantages and features thereof, there now follows a more detailed description of the methods used and the compositions disclosed. It should be clear that nothing in the description given hereunder is to be interpreted as a limitation of the protection claimed in the claims for the present invention.

The present disclosure relates on the one hand to a method for treating wood with red and/or pink undertones to bring it to the desired colour. On the other hand the disclosure relates to a composition (kit) for treating wood with red and/or pink undertones, which is suitable for neutralizing the red and/or pink undertones of the wood to be treated.

The method (and composition) according to the disclosure is in particular suitable for being applied on American red oak, beech, birch, maple, Tasmanian oak, white oak (when for example it has anomalous colours), etc. In principle, this method (and composition) is applicable to nearly all wood species that are of light hue and anomalous red.

The development according to the present disclosure has the innovative feature that the surface of wood with ‘pink hue’ as a typical feature can as it were be reset by a specially developed staining treatment, which is universally applicable, both industrially and on-site with the existing techniques, so that it can then be further finished with the known techniques and/or products. The wood substrate acquires a definite added value thereby.

Stains based on pigments are, owing to the covering nature of the colouring elements, very suitable agents for modifying—covering up—the colour of a substrate, preferably a well-defined wood species, but have the disadvantage that the wood structure and the natural effect are largely lost, so that they will not come into consideration for the aim of this innovation. Nevertheless, this technology is used to a certain degree for upgrading inferior wood species but the degrees of freedom in finishing are limited. Another approach is that by making use of colour theory by means of a subtractive mixture of transparent dye stain and substrate, the colour of the wood is reset: neutralized. However, it becomes innovative when by applying a first stain (neutralization layer or neutralization mixture), a bond is produced which is embedded stably and insolubly in the fibres and is free from binder and is sufficiently transparent so that application of a second water-based layer (second stain) becomes possible without dissolving the previously applied layer (first stain) again and all degrees of freedom of finishing are maintained, and in addition on wood species which to date have not come into consideration for such applications.

An important component of this innovation is the composition of the neutralization layer. Reactive dyes, for which it is known that, in contrast to the other types that are available for colouring wood, they undergo covalent bonding with the cellulose fibre, form an essential component of the neutralization layer. Knowing that in the wood-processing industry it is usual to supply ready-to-use wood stains, yet we wish to employ a colouring mechanism based on reactive dyes, then in order to be able to guarantee a product with a long enough shelf life, an answer must be found for the problem of hydrolysis that is associated inherently with the colours of reactive dyes. A technical solution was found in splitting the neutralization mixture (stain) into two compatible components, namely a first component (A) that contains the required colour combination and a second component (B) that constitutes the reactive portion, the latter in the alkaline pH region.

Ageing stains, the mechanism of which is based on reaction between stain and constituents (including tannin) of the wood, now make up an important part of the market in the high-end flooring segment. The demand for finishes of this type is at present greater than the availability of suitable substrate; being able to employ alternative wood species, which currently do not come into consideration on account of their individual character and the state of finishing techniques, would constitute a technological innovation. Since the activity of the neutralization layer is based on affinity with respect to cellulose, there is no competition between the two types of stains, and combining said neutralization layer and ageing stain is an ideal scenario for obtaining aged finishes on wood substrates which at first sight, in particular on account of their pink coloration, are less suitable. This was confirmed in practice, and such finishes are described further in the examples accompanying the description.

For preparing the first component (A), preferably reactive dyes that are commercially available are used, preferably reactive dyes from the vinyl sulphone group. The dyes are selected on the basis of light-fastness, moderate reactivity (basically less sensitive to hydrolysis) and suitability for the so-called KKV process. The KKV process (German term: Klotz Kurzverweil Verfahren/English term CPB—cold pad batch) is a widely used technique for reactive dyeing a textile and in its most original form, the textile is pulled through a bath in which dye solution and an amount of alkali required for fixation are added together, after impregnation the textile is wound up again and usually wrapped in film to prevent drying-out of the edges and the top layers of the roll during the resting/reaction time, depending on the dye composition it is stored for a period from 4 to 12 hours until the reaction of the reactive dyes is completed and is then unwound again, to be washed (non-fixed dyes, alkali, etc.) and finally dried and wound up.

More particularly, the dye solution that forms the first component (A) and whose pH is set between 3 and 5 (ideally pH 4) will be a mixture that comprises one or more reactive dyes from the vinyl sulphone group and a buffer pair NaAc/HAc.

Because the colour combination requires great precision and the percentages of dye required for the purpose are low, it is preferable to work with master solutions of the aforementioned dyes, adjusted to 10% standard dye strength. Results of application tests carried out on 3 typical laboratory compositions after 4 weeks of storage at 5° C. and at 50° C. were comparable to the reference, so that we can assume that long-term stability is achieved. Furthermore, it is not excluded that for specific applications, a small amount of an aqueous TiO₂ preparation may be added to the recipe.

A typical composition of the first component contains for example: 95 to 97% water, 0.2 to 0.45% sodium acetate, 0.5-1.5% reactive dye, 0.01-0.08% preservative and 1-2% acetic acid (40%) to pH 4.

The second component (B), also called the reactive component, comprises chemicals that are important for application, diffusion, adsorption and fixation. Additives that work effectively in low-viscosity systems free from strong polar binders and display pseudo-plasticity and/or thixotropy are preferred for adjusting the rheology. Bentonites and Ca-bentonite in particular, fumed silicas, mixtures of fumed silica and dispersed aluminium oxide and co-fumed products thereof may be used for this purpose. Urea acts as a moistener, it prevents the wood fibre drying out during the reaction period (open air), urea increases the swelling of the fibre and is able to break hydrogen bridges, thus improving the penetration and mobility of the dye. Moreover, it is known that urea increases the limits of solubility of dyes, which may be useful when a strong solution is necessary. Urea is the preferred moistener, but other moisteners, such as e.g. propylene glycol, are not excluded. The fixation, covalent bonding, between dye and cellulose fibre takes place in a buffered alkaline medium. Fixation alkalies such as NaOH, KOH, Na₂CO₃, NaHCO₃, Na₂B₄O₇, Na₂SiO₃ and combinations thereof are usable for this. Fixation is an important aspect, and is controlled by maintaining the correct pH. The type of alkali that is used provides a correct pH and optimum fixation. Depending on the ratio of dye to water, electrolytes may be necessary to help the dye to leave the aqueous solution and enter the fibre, where it can react.

Reactivity of the dye, pH range and temperature are determining for the rate of reaction and hydrolysis. It is known that alkaline substances and chemicals such as ammonia can react with wood with a high content of polyphenolic tannins, and cause a brown discoloration, setting a lower pH of the second component is advantageous here, and in addition this has a positive effect on the degree of hydrolysis, but it results in a slower reaction rate with cellulose fibres. As established experimentally, this need not necessarily lead to poorer fixation. Wood species with lower content of constituents and which are thus less sensitive to the undesirable brown discoloration can have a higher pH.

A typical composition of the second component contains for example: 75 to 90% water, 0.2 to 1.2% fumed silica, 0.3-0.7% Ca-bentonite, 10 to 12% urea, 0-1% propylene glycol, 2 to 10% fixation alkalies, wherein the pH setting is between 9.5 and 11.2.

The first and the second component are stored separately, it is only at the time of application that the two components are mixed together, so as to form a composition for treating wood with red and/or pink undertones, which is suitable for neutralizing the red and/or pink undertones of the wood to be treated, a so-called neutralization solution. For each component individually, a shelf life can be guaranteed, which makes it possible to market the system as a ready-to-use two-component neutralization solution (stain). A solution is thus offered for the problem of hydrolysis of the reactive dye as a function of time. At the time of application, the first component (A) and the second component (B) are mixed in a 50/50 ratio. To date, it has not been found that the neutralization solution loses its activity within a realistic operating time.

With regard to the type of wood on which this neutralization solution may be applied, there is no fundamental limitation, any type of wood that naturally has a red hue may be considered. Certain wood species are easier to colour than others, and certain species (e.g. red oak) may preferably be considered from the economic standpoint.

For optimum dye take-up, the wood must be prepared correctly. Pretreatment (conditioning) of the wood substrate consists as a rule of several sanding operations, and in the last sanding operation the grain number is selected to be suitable for the particular wood species and as a function of the desired end result. For extra accentuation of the wood structure, additionally a brushing treatment (wire brush and/or Tinex) may be applied, and exceptionally, planed substrates may be used.

In practice, for application of the neutralization solution consisting of a 50/50 mix of the two components, it is understood that the neutralization solution is sprayed, applied with a roller and possibly by a vacuum-coating system. All existing techniques and production installations may be considered for this. On site, the stain is applied with a brush. The amount to be applied may vary, as a function of substrate and technique, between 40 and 80 g/m², ideally 60 g/m² is applied and is levelled afterwards.

To make the time for adsorption, diffusion and reaction between the neutralization solution and cellulose fibres of the wood as long as possible, it is preferably air-dried. A high relative humidity is advantageous. A so-called “reaction time” of at least 6 to 8 hours is anticipated; forced drying may give rise to poorer fixation.

Following this, a (first) finishing layer (second staining operation, wherein application of the neutralization layer is regarded as the first staining operation) may be applied. Because application of an ageing stain, for example from the range known under the brand name Ciranova, offers the greatest added value, this type of stain is used ideally, without being limiting. Tests with water-based pigment stains as the second staining operation have, rather surprisingly, made finishes possible on certain wood species that could not be produced without applying a neutralization layer. Transparent finishing, i.e. without application of a finishing layer, offers possibilities, by means of an appropriate formulation of the colouring component, for producing modern, natural-looking finishes.

“Finishing” generally means the application of a functional protection, which for industrial applications is as a rule of photochemical nature (UV Oil or UV Varnish) and for on-site applications it is either an oxidatively drying oil or a water-based varnish, which may or may not be preceded by extra colouring by applying a second water-based stain. Ideally but not absolutely necessarily, a sealer with a typical composition is applied between the colouring operations and the functional finishing, for extra fixing of the underlying colour combination. A particular feature of this is that the natural appearance of the wood is preserved, we see, as the main application, enabling typical finishes on wood species that are less suitable for this by nature.

Some examples are described below, wherein a number of wood species were provided with a composition (neutralization solution) according to the disclosure. In the tables, PB2C is used as the abbreviation for the neutralization solution, wherein the numbers 1239, 1240, 1241, 1242 are the patent holder's internal reference numbers for the first component and the numbers 7953, 8501, 7953, 8417 are the patent holder's internal reference numbers for the second component.

### Example 1

Because of non-availability of the standard European white oak substrate, a relatively simple aged finishing was applied on white oak derived from Northern Europe (with some older slow-growing trees, the wood may have a pink colour) with the result that the finish had a pink undertone. Because the rest of the production process can be maintained, application of the method according to the disclosure is an ideal solution for this.

TABLE 1

| | | | | Details | | |
|---|---|---|---|---|---|---|
| Step | Prod. | | | | No. EU White | No. EU White |
| substrate | Type | application | | EU White oak | oak | oak |
| Step X | PB2C | 60 | g/m² | | | Mix |
| Step 1 | Ageing stain | 50 | g/m² | 230-002061 | 230-002061 | 1239/7953 |
| Step 2 | | 10-15 | g/m² | 175-005232 | 175-005232 | 230-002061 |
| Step 3 | UV Oil natural | 6-8 | g/m² | 680-005149 | 680-005149 | 175-005232 |
| | white | | | | | 680-005149 |
| | UV Oil clear matt | | | | | |
| | | | | Reference | Pinkish | =Reference |

### Example 2

American Red oak, a possible alternative for the expensive European white oak, which is of limited availability, has a typical pink/red hue and is therefore unsuitable in its present form. Application of the method according to the disclosure makes it possible to produce attractive finishes on American red oak which bear comparison with European white oak. Application of a water-based sealer between stain and finish accentuates the natural effect.

TABLE 2

| Step | | | | Details | | | |
|---|---|---|---|---|---|---|---|
| substrate | Prod. Type | application | | US Red Oak | US Red Oak | US Red Oak | US Red Oak |
| Step X | PB2C | 60 | g/m² | | Mix | Mix | Mix |
| Step 1 | Ageing stain | 50 | g/m² | | 1239/8501 | 1239/7953 | 1239/7953 |
| Step 2 | WB Sealer Oculto | 50 | g/m² | | | 230-001972 | 230-007942 |
| Step 3 | UV Oil base clear | 10-15 | g/m² | 680-007413 | 163-007285 | 163-007285 | 163-007285 |
| Step 4 | UV Oil clear matt | 6-8 | g/m² | 680-005149 | 680-007413 | 680-007413 | 680-007413 |
| | | | | | 680-005149 | 680-005149 | 680-005149 |
| | | | | Pinkish | Natural | =EU Quality | =EU Quality |

### Example 3

Maple is a wood species that is often used in North America, but a disadvantage is that white finishes have a pink sheen. Use of the composition and application of the method according to the disclosure is ideal for this. It can be seen from a comparative test (8 h reaction/open air/½ sample washed out) with fixation alkalies such as Na₂CO₃, Na₂SiO₃ and Na₂B₄O₇/Na₂CO₃ mix that this is usable for the method according to the disclosure.

TABLE 3

| Step | | | | Details | | | |
|---|---|---|---|---|---|---|---|
| substrate | Prod. Type | application | | Hard Maple | Hard Maple | Hard Maple | Hard Maple |
| Step X | PB2C | 60 | g/m² | | Mix | Mix | Mix |
| Reaction | | | | | 1240/8417 | 1241/8417 | 1242/8417 |
| time | UV Oil X-tra | 10-15 | g/m² | 680-005510 | 8 Hr | 8 Hr | 8 Hr |
| Step 1 | White | 6-8 | g/m² | 680-005149 | 680-005510 | 680-005510 | 680-005510 |
| Step 2 | UV Oil clear matt | | | | 680-005149 | 680-005149 | 680-005149 |
| | | | | Pinkish | Neutral | Neutral | Neutral |

### Example 4

Beech is used in Europe for interior applications, such as staircases, plank floors and furniture and is sometimes steam-treated, which makes the wood pink. Tests on steamed beech have shown that the pink hue can be suppressed considerably when the composition and application of the method according to the disclosure are used.

TABLE 4

| | | | | Details | |
|---|---|---|---|---|---|
| Step | Prod. | | | Steamed | Steamed |
| substrate | Type | application | | Beech | Beech |
| Step X | PB2C | 60 | g/m² | | Mix 1239/8417 |
| Step 1 | Aquapad | 50 | g/m² | 240-006363 | 240-006363 |
| | White | | | | |
| Step 2 | UV Oil | 10-15 | g/m² | 175-006508 | 175-006508 |
| | white | | | | |
| Step 3 | UV Oil | 6-8 | g/m² | 680-005149 | 680-005149 |
| | clear matt | | | | |
| | | | | Pinkish | ±Neutral |

### Example 5

The reactive component based on propylene glycol as moistener was tested on a standard commercial finishing, with American red oak as substrate. It proved effective, with colour combination comparable to the recipe based on urea.

TABLE 5

| Step | Prod. | | | Details | | |
|---|---|---|---|---|---|---|
| substrate | Type | application | | US Red Oak | US Red Oak | US Red Oak |
| Step X | PB2C | 60 | g/m² | | Mix 1239/7953 | Mix 7993/7953 |
| Reaction | | | | | overnight | overnight |
| time | Ageing stain | 50 | g/m² | 230-002061 | 230-002061 | 230-002061 |
| Step 1 | UV Oil natural | 10-15 | g/m² | 175-005232 | 175-005232 | 175-005232 |
| Step 2 | white | 6-8 | g/m² | 680-005149 | 680-005149 | 680-005149 |
| Step 3 | UV Oil clear matt | | | | | |
| | | | | Pinkish | =EU Quality | =EU Quality |

1. A method for treating wood with red and/or pink undertones to bring it to a desired colour, wherein the wood is provided with one or more finishing layers with the desired colour, comprising:
providing the wood with a neutralization layer before the one or more finishing layers are applied, in order to neutralize the red and/or pink undertones of the wood to be treated;
wherein the neutralization layer is a mixture of a first and a second component, which is applied as a single composition;
wherein the first component is a solution of a reactive dye in water and the second component is an aqueous alkaline solution suitable for forming covalent bonds with the fibres of the wood to be treated.

2. The method according to claim 1, wherein the first component has a pH value between 3 and 5, preferably 4.

3. The method according to claim 1, wherein the second component comprises at least 97% water.

4. The method according to claim 1, wherein the second component has a pH value between 8.5 and 12.5.

5. The method according to claim 1, wherein the alkaline solution comprises urea.

6. The method according to claim 1, wherein the alkaline solution comprises at least 75% water.

7. The method according to claim 1, wherein the ratio of the first to the second component in the neutralization layer is 50/50.

8. The method according to claim 1, wherein the first finishing layer that is applied on the neutralization layer comprises a water-based colouring stain or an ageing stain.

9. A kit of two different aqueous solutions, which are applied as a single composition for treating wood with red and/or pink undertones, which is suitable for neutralizing the red and/or pink undertones of the wood to be treated, comprising:
a mixture of a first and a second component;
wherein the first component is a solution of a reactive dye in water and the second component is an aqueous alkaline solution suitable for forming covalent bonds with the fibres of the wood to be treated.

10. The kit according to claim 9, wherein the first component has a pH value between 3 and 5.

11. The kit according to claim 9, wherein the second component has a pH value between 8.5 and 12.5.

12. The kit according to claim 9, wherein the ratio of the first to the second component is 50/50.

13. The method according to claim 5, wherein the alkaline solution comprises 8% to 15% urea.

14. The kit according to claim 10, wherein the first component has a pH value of 4.
